(19) United States
(12) Patent Application Publication
(10) Pub. No.: US 2025/0079031 A1
(43) Pub. Date: Mar. 6, 2025

(54) Radiation protection material, radiation protection device, and method for manufacturing a radiation protection device

(71) Applicant: MAVIG GmbH, Muenchen (DE)

(72) Inventor: Christian Stoian, Muenchen (DE)

(73) Assignee: MAVIG GmbH, Muenchen (DE)

(21) Appl. No.: 18/825,270

(22) Filed: Sep. 5, 2024

(30) Foreign Application Priority Data
Sep. 5, 2023 (EP) 23 195 386.0

(51) Int. Cl. G21F 1/10; G21F 1/08; G21F 3/03; G21F 3/035

(52) U.S. Cl. CPC G21F 1/106; G21F 1/085; G21F 3/03; G21F 3/035

(57) ABSTRACT

A radiation protection device comprising at least one metal-containing layer, the metal portion of the metal-containing layer being at least 50% by weight, the binder structure of the metal-containing layer having a Shore 00 hardness less than or equal to 100 and/or the binder structure of the metal-containing layer having a thickness less than or equal to 1.1 g/cm³. A method for manufacturing a radiation protection device of this type, the material of the metal-containing layer being applied by adhesion to a support and/or support material and/or fabric strip by powder coating and/or calendering and/or injection moulding and/or blow moulding and/or lamination.

### RELATED APPLICATIONS

This application claims priority to EP 23 195 386.0, filed on Sep. 5, 2023, the entirety of which is hereby incorporated by reference.

### FIELD

The invention relates to a novel radiation protection material and a radiation protection device, in particular for shielding of X-ray radiation (X-rays), as well as to the manufacture of said protection material and its uses. The material is preferably used in form of a layer. The layer may also be in the form of a coating of another material (fabric or fibre).

### BACKGROUND

Radiation protection devices serve to protect individuals from harmful high-energy radiation. They consist of special materials which weaken or block the radiation. These devices are positioned between the radiation source and the individual to be protected, so as to minimise exposure to radiation. Examples include lead aprons for patients and medical staff and leaded windows in X-ray rooms, which absorb and scatter the radiation so as to reduce the risk for individuals outside the area of examination.

In radiation protection materials, suitable metals are often worked into a matrix. This matrix may also be a binder. A common binder for this purpose is natural rubber, for example plastisol. As is described on Wikipedia, plastisol is a dispersion of a pulverulent thermoplastic polymer in a liquid plasticiser, optionally containing pigments, fillers and additives, such as propellants.

The use of plastisol is disadvantageous, as t the radiation protection materials and devices have a high weight and a high Shore 00 hardness. Moreover, articles made of plastisol can only be recycled with great difficulty.

WO2022/002811 A3 describes the manufacture of a metal-containing layer for manufacturing X-ray aprons, which contains polyurethane as a binder, the metal-containing layer being applied by screen printing.

In combination with screen printing methods, the use of polyurethane as a binder is inconvenient because the starting materials for the polyurethane (and optionally further additives) have to be supplied to the screen printing individually. Prior to printing, these components (starting materials and optionally additives) have to be mixed very well, resulting in a composition (reaction mass) which is subsequently printed. This procedure as such is very laborious, takes a long time, and requires special sealing materials to be used. Manufacturing the materials is therefore very uneconomical, and it is desirable to find alternative materials and methods which avoid the aforementioned drawbacks.

Ideal radiation protection materials from which radiation protection devices, in particular X-ray protection devices (such as clothing and aprons), can be manufactured should be light and flexible, in other words have the lowest possible Shore hardness and simultaneously have a sufficient radiation protection effect.

### SUMMARY

Therefore, the object of the invention is to provide radiation protection materials and devices which have the aforementioned advantages and are additionally easy to manufacture. If the materials are processed into radiation protection clothing, then the comfort of wear is also to be improved.

Moreover, it would be advantageous if the radiation protection materials and devices were easy to dispose of and in particular recyclable.

The inventors have now found that the present invention overcomes several of the drawbacks of the prior art and moreover is suited to achieving the said objects.

Unless stated otherwise, the hardness of the binder structure of the metal-containing layer (and thus also the elasticity) is defined using the Shore hardness testing method and hardness scale. Shore hardness testing is a simple and effective substance testing method and a simple method for measuring the hardness of elastomers and deformable plastics materials.

Shore hardness is understood to mean the resistance of a substance to the penetration of a conical body of particular dimensions under a defined contact force. Depending on the configuration of the specimen, there is a distinction between different Shore hardness categories (for example Shore 00 (very soft, elastic substances), Shore A (soft, elastic substances), Shore D (hard substances) etc.).

There is a correlation between the Shore hardnesses measured in the different categories, and they can be converted into one another. FIG. 8 shows a correlation/correspondence of this type between Shore 00, Shore 0, Shore A, Shore B, Shore C and Shore D values. According to the correlation in FIG. 8, for example, 50 Shore A corresponds to approximately 10 Shore D, 75 Shore A to approximately 20 Shore D, and 20 Shore A to approximately 70 Shore 00. According to the invention, this correlation in FIG. 8 can be used to convert Shore hardness measured in different categories into Shore 00 hardnesses.

Shore A values are reproduced in FIG. 8. Shore A is defined under DIN ISO 7619-1. This standard is the most commonly used hardness testing method for soft elastic materials. To measure the Shore hardness correctly, a sample thickness of 6 mm is prescribed. Measurements on thinner samples generally lead to incorrect results.

Metals may be used to manufacture the material and be present in the material in an elemental, ionic or complexed form.

Unless stated otherwise, the term “metal-containing” refers to a material containing a metal in any form (elemental, ionic or complexed).

Within the meaning of the present invention, the term “ionic-metal-containing” denotes a material containing ionic metal compounds; in other words, the metal or metals are present as ions. By way of example, metal oxides are compounds of this type, since the metal is present in oxidised form and not in elemental form.

Within the meaning of the present invention, the term “pure-metal-containing” denotes a material containing metal in elemental form.

In connection with the mesh width, the unit “mesh” is used especially in the English-speaking world and primarily for sieves. At the same time, “mesh” also denotes the particle size of the sieved material. A sieve having five meshes per inch (25.4 mm) has a value of 5 mesh. However, since the thickness of the mesh wires also needs to be considered, 5 mesh does not correspond to a particle size of a fifth of an inch (5.1 mm), but rather to a particle size of 4.0 mm (namely 78% of ⅕ of an inch). A particle size of 10 mesh corresponds to a particle diameter of 2.0 mm. For large mesh numbers, there are differences in particle sizes depending on the standard used. Thus, 100 mesh (1 mesh per 0.254 mm) does often correspond to a particle size of 0.149-0.150 mm (59%), but, depending on the purpose of use, the authority and the country, may also be defined as 0.162 mm (64%, FEPA standard P100 for sandpaper), 0.129 mm (51%, FEPA standard F100 for grinding tools) or 0.125 mm (49%, J100 under Japanese standard JIS R6001). Comparison is then no longer possible without a corresponding table or exact knowledge of the associated standards. However, if an error of at most 25% is accepted, the particle sizes between 5 and 100 mesh can be approximated well as 16.2 mm divided by the mesh value. In the present disclosure, unless stated otherwise, FEPA standard P100 for sandpaper is used to approximate the actual particle sizes.

In plastics processing, calendering is understood to mean shaping heated, flowable masses into continuous webs using at least two rollers. Before the plastics material can be calendered, it needs to be brought into a flowable state. For this purpose, the polymer mixture is heated and melted in an extruder or kneader. Added additives and fillers are thus distributed homogeneously in the polymer melt. The plastics mass then arrives in a roller system via a conveyor belt, and is rolled out flat between the two heated rollers of the calender in a continuous process. The layer thickness may be set by way of the gap width between the rollers. After passing through the calender, the film is cooled on cooling rollers, received by take-off rollers, optionally stretched, and either wound up or cut and stacked. The film may also be further treated by embossing, smoothing, printing, flocking or metal-coating. Often, refining steps such as embossing and stretching are integrated into the calendering line, in such a way that the webs do not have to be heated again.

It is known to use lead as a metal in radiation protection materials, in particular in those suited for protection from X-rays.

An aim of the application is to provide a novel recyclable material which meets the requirements.

A further aim of the invention is to reduce or completely replace the lead portion, and in particular to provide lead-free radiation protection material and radiation protection devices.

Lead is a high-Z material, in other words an element having a high atomic number or proton number. Because of its high atomic mass, lead is suited for shielding against gamma and X-ray radiation; it absorbs X-ray and gamma radiation very effectively. As a high-Z material, lead shields very effectively against the X-ray radiation in the clinically relevant region of 50-150 kV, (almost) independently of the X-ray tube voltage. Lead is convenient and easier to process than metals which have higher atomic mass and are thus denser. It is therefore generally used for shielding in radiation protection, for example nuclear medicine, radiology or radiation therapy. One example is protective lead aprons, which doctors and patients wear when X-ray images where taken. Leaded glass is likewise used for radiation protection. Protection material comprising lead therefore has a stable lead equivalent in the range of 50-150 kV. On the other hand, however, a high atomic number also means a higher weight of the protection material.

According to the invention, in reduced-lead or lead-free embodiments of the invention relating to shielding against high-energy radiation, another metal or metal mixtures may be used instead of or together with lead, which metal is selected from tungsten (W), bismuth (Bi), tin (Sn), antimony (Sb) and barium (Ba), alone or in mixtures and/or alloys, in elemental or ionic form (for example in the form of metal oxides) or in complexed form. Possible mixtures are for example tungsten and/or bismuth and/or barium and/or antimony and/or tin and/or compounds thereof such as barium sulphate.

The lead equivalent varies as a function of X-ray tube voltage. The degree of the fluctuations in the lead equivalent depends on the materials with which lead is replaced and the amount thereof.

In practice, this means that radiation protection materials (for example radiation protection aprons) comprising lead-free or reduced-lead protection material generally only meet the specified lead equivalent within the tolerances for an X-ray tube voltage range of 50-110 kV, and thus are also only allowed to be used for this range.

In lead-free protection material, the metal lead is fully replaced with other metals, advantageously with tungsten (W), bismuth (Bi), tin (Sn), antimony (Sb) and barium (Ba), alone or as mixtures and/or alloys, in elemental, ionic (for example in the form of metal oxides) or complexed form.

In reduced-lead materials, some portion of lead is replaced with these other metals. These other metals usually have a lower atomic number than lead. This has the advantage that the lead-free or reduced-lead protection material is lighter (for the same area), but low-Z materials do not shield as well at low and high X-ray tube voltages.

Radiation protection materials usually contain exclusively lead in an elemental, ionic or complexed form.

For partially or completely replacing lead for the manufacture of radiation protection materials and the use thereof in radiation protection devices, well-suited metals preferred according to the invention are for example tungsten (W), bismuth (Bi), tin (Sn), antimony (Sb) and barium (Ba), alone or as mixtures and/or alloys, elementally or ionically (for example in the form of metal oxides) or as metal complexes.

The inventors have found that thermoplastic elastomers and thermoplastic elastomer mixtures, respectively, as well as hot melts are suited for the manufacture of metal-containing materials, particularly as a coating material, resulting in a stable composite. In this context, they are used as binders. It has likewise been found that the metal-containing material is very well-suited for coating fabrics or fibres, making numerous applications conceivable. The metal-containing material or—if the material is used in the form of a layer—the metal-containing layer has a very advantageous low Shore 00 hardness, and the binder structure has a low density, resulting in a sufficiently soft and stable metal-containing material which can be further processed easily and is also recyclable. The low density is advantageous because the weight of the processing products is low. The radiation protection property is achieved through the selection of the metals in the metal layer. The inventors have found that it is particularly advantageous to use a combination of the well-suited metal and its metal oxide.

In addition to the known good radiation protection effect when lead is used as the metal, the inventors have further found that a sufficient radiation protection effect can also be achieved with only a small proportion or without the use of lead and/or its compounds.

The invention thus is also directed to the provision of a reduced-lead material containing at least two of the following metals (in elemental form and/or in at least one ionic form and/or in complexed form), the metals being selected from lead (Pb), bismuth (Bi), tin (Sn), antimony (Sb) and barium (Ba), and of radiation protection devices manufactured therefrom and intended to be used in particular for protection from X-rays.

The invention is further directed to the provision of a lead-free material containing at least one of the following metals (in elemental form and/or in at least one ionic form and/or in complexed form), the metals being selected from bismuth (Bi), tin (Sn), antimony (Sb) and barium (Ba), and of radiation protection devices manufactured therefrom and intended to be used in particular for protection from X-rays.

The invention also relates to the manufacture of radiation protection devices in which the material is present as a coating or is present in a simple or multiple sandwich structure (for example as an intermediate layer).

Hot melts are solvent-free polymer-based adhesives which are solid at room temperature. They are applied or processed in a hot, molten state. In general, hot melts consist of a base polymer (which may be present in various forms) and additives. These additives include resins (for example rosin, terpene, hydrocarbon resins), waxes, stabilisers, antioxidants and plasticisers. Other chemicals may also be present to give the hot melt other desired properties.

The base polymers of the hot melts useable according to the invention comprise: polyamides (PA), polyethylenes (PE), polypropylenes (PP), ataxic polypropylenes (a-PP), polyolefins, amorphous polyolefins (APAO), ethylene vinyl acetate (EVA), ethylene vinyl acetate copolymers EVAC, polyesters, polyester elastomers (TPE-E), polyurethane elastomers (TPE-U), copolyamide elastomers (TPE-A), vinyl pyrrolidone/vinyl acetate copolymers, styrene block copolymers, for example SEBS, polyethylene and polystyrene.

Hot melts containing ataxic polypropylene (a-PP) or styrene block copolymers, for example SEBS, are particularly preferred.

Solvent-free polymer-based hot melts can be processed rapidly and cost-effectively. They are more adhesive than the solvent-containing hot melts, and fewer volatile organic compounds occur during processing.

The melting points of these hot melts are generally in the range between 8° and 220° C.

Hot melts preferred according to the invention contain the ataxic polypropylenes or styrene block copolymers, for example SEBS, as a base polymer.

The inventors have found that in the manufacturing of the material a sufficient metal concentration for the radiation shielding effect is achieved if the metal component(s) are predispersed with a component of the elastomer or hot melt and the remaining components of the binder (for example hot melt) are only added to the mixture after this predispersion.

In a variant of the method according to the invention, the metal and/or the metal compound is predispersed with a-PP or SEBS, and followed by the addition of the remaining components of the relevant hot melt. Due to predispersing the metal with the base component of the hot melt, in accordance with the invention, not only can a sufficient shielding concentration be achieved, but the material also acquires its soft nature as a result. At the same time, there is no significant cavity or aggregate formation in the end product.

The metal-containing material may be used as a coating material. This metal-containing layer may be applied to a support or be located on a support or be located between two supports or support webs. The supports coated with the material according to the invention may be multi-layered and comprise further coatings (for example, further antibacterial metal layers may also be present).

The use of hot melt as a binder is preferable here, and moreover has the advantage that, if the material is applied to at least one support (this may be a fabric, woven fabric or the like), the support can be selected freely depending on the subsequent use.

As a result, the use and processing of the radiation protection device manufactured using the material according to the invention becomes more versatile. If for example microfibre is used as a support, this increases the wearing comfort for the individual wearing the radiation protection device (for example X-ray apron). It is also advantageous if the support is easy to clean.

The support no longer needs necessarily consist of a very dense and tear-resistant material (such as woven polyester fabric), since hot melt is non-toxic, unlike the conventionally used plastisol. Therefore, tearing the support does not lead to toxic exposure.

Thus, in an embodiment, the invention also relates to a radiation protection device containing at least one metal-containing layer, the metal portion of the metal-containing layer being at least 50% by weight, the binder of the metal-containing layer being a hot melt.

If the metal-containing layer is arranged between two support layers, one of these support layers may advantageously consist of polyester. The other layer may consist of polyester or a woven fabric such as microfibre or TPU or PP non-woven or PE non-woven. The supports may be in the form of support strips (support webs), in such a way that the radiation protection device is manufactured as a sheet material.

In an advantageous embodiment [A], the invention relates to a radiation protection material (in particular X-ray protection device) consisting at least of a binder and at least one metal, the at least one metal being in its elemental form and/or in at least one ionic form and preferably being selected from lead (Pb), tungsten (W), bismuth (Bi), tin (Sn), antimony (Sb) and barium (Ba), the metal content of the at least one metal being greater than or equal to 50% by weight and the density of the binder structure being less than or equal to 1.1 g/cm³ and having a Shore 00 hardness of at most 100. The radiation protection material is preferably processed in the form of layers, whereas according to the invention the term layer includes a coating, i.e. a layer applied to a support or fibre. Preferably, radiation protection devices (in particular X-ray protection devices) are manufactured from the radiation protection material.

In an advantageous embodiment [B], the invention relates to a radiation protection material (in particular X-ray protection device) as described in embodiment [A], the at least one metal being in elemental form or in ionic form (for example as a metal oxide, sulphate, carbonate), for example Pb, Pb²⁺ ions, W, W⁴⁺ ions, Bi, Bi³⁺ ions, Bi₂O₃, Sn, Sn²⁺ ions, SnO, Sb, Sb³⁺ ions, Sb₂O₃, Ba, Ba²⁺ ions, BaO or mixtures thereof.

In an advantageous embodiment [C], the invention relates to a radiation protection material (in particular X-ray protection device as described in a previous embodiment, at least 25% of the metal portion in the radiation protection material coming from metal oxide(s)). Preferably, the portion of metal coming from metal oxides is at least 30%, 35%, 40%, 45%, 50%, 55%, 60%, 70%, 75% or 78%. The maximum limits take on the following values: 100%, 95%, 90%, 80%, 75%, 60%, 55%, 50% or 45%.

In an advantageous embodiment [D], the invention relates to a radiation protection material (in particular X-ray protection device as described in a preceding embodiment), only one metal being used, or at least 2 metals being used, each of these metals being used elementally and/or ionically and/or in a complexed form. Alloys of metals are also possible.

In an advantageous embodiment [E], the invention relates to the radiation protection material or radiation protection device (in particular X-ray protection material or X-ray protection device) as defined in embodiment [A], the binder being selected from hot melt, thermoplastic elastomer and thermoplastic elastomer mixture, and the binder structure of the metal-containing material or of the layer having a density of at most 1.1 g/cm³ or the density thereof being in one of the following ranges: 0.85 g/cm³ to 1.1 g/cm³, 0.85 g/cm³ to 1.05 g/cm³, 0.85 g/cm³ to 1 g/cm³, 0.85 g/cm³ to 0.95 g/cm³, and 0.85 g/cm³ to 0.9 g/cm³.

In an advantageous embodiment [F], the invention relates to a radiation protection material or radiation protection device (in particular X-ray protection material or X-ray protection device) as defined in one of the preceding embodiments, a hot melt based on a-PP or SEBS being used as the binder.

In an advantageous embodiment [G], the invention relates to a radiation protection material or radiation protection device (in particular X-ray protection material or X-ray protection device) as defined in one of the preceding embodiments, the ratio between the metal portion and binder portion being within the ranges disclosed in the present application, for example 70 wt.-% metal portion and 30 wt.-% binder portion.

In an advantageous embodiment [H], the invention relates to a radiation protection material or radiation protection device (in particular X-ray protection material or device) as defined in one of the preceding embodiments, in which the binder structure of the material or—if the material is processed as a layer—of the metal-containing layer has a shore 00 hardness in a range of approximately 25-95 g/cm³, in particular of approximately 25-65 g/cm³, of approximately 30-65 g/cm³ or of approximately 45-80 g/cm³. The Shore 00 hardness may also be as follows: less than or equal to 95 g/cm³, less than or equal to 90 g/cm³, less than or equal to 85 g/cm³, less than or equal to 80 g/cm³, less than or equal to 75 g/cm³, less than or equal to 70 g/cm³, or less than or equal to 65 g/cm³. Likewise, it may be greater than or equal to 25 g/cm³, greater than or equal to 30 g/cm³, greater than or equal to 35 g/cm³, greater than or equal to 40 g/cm³, greater than or equal to 45 g/cm³, greater than or equal to 50 g/cm³, greater than or equal to 55 g/cm³ or greater than or equal to 60 g/cm³.

In an embodiment [I], the invention relates to a radiation protection material or radiation protection device (in particular X-ray protection material or device) as described in one of the preceding embodiments, in which the elemental metal has the following maximum particle size: 110 μm, 100 μm, 90 μm, 80 μm, 70 μm, 60 μm, 50 μm or 40 μm or where the minimum particle size is 40 μm, 50 μm, 60 μm, 70 μm, 80 μm, 90 μm or 100 μm.

If the metal layer contains metals in an ionic or oxidised form, according to the invention the following maximum particle sizes are advantageous: 10 μm, 1 μm and approximately 500 nm.

In an embodiment [J], the invention relates to a radiation protection material or radiation protection device (in particular X-ray protection material or device) as described in one of the preceding embodiments, in which the metal portion of the elemental metal has the following minimum particle size: 140 mesh, 170 mesh, 200 mesh, 250 mesh, 300 mesh, 350 mesh or 400 mesh. Likewise, it is advantageous if the maximum particle size is 400 mesh, 350 mesh, 300 mesh, 250 mesh, 200 mesh, 170 mesh, 140 mesh.

According to the invention, the value is in a range of 300-350 mesh.

In an embodiment [K], the invention relates to a radiation protection device as described in one of the preceding embodiments, comprising one or more supports (possibly in the form of support strips).

In an embodiment [L], the invention relates to a radiation protection material or radiation protection device (in particular X-ray protection material or X-ray protection device) as described in one of the preceding embodiments, the solid portion of the metal layer having metal particles in elemental form having an average diameter in a range of 5-100 μm, 20-80 μm or 40-60 μm, in particular if the material is used as a layer.

The radiation protection device then consists of a metal-containing layer which is applied to the support or arranged between at least two supports. The support or supports may be selected freely depending on the application. Materials such as microfibre, TPU, PP non-woven or PE non-woven are conceivable. If two supports are used, the materials of the supports may also be different. It is thus conceivable for example to manufacture a radiation protection device having a sandwich construction in which the metal-containing layer is arranged between PE non-woven and microfibre.

The material according to the invention forms a radiation protection device which is processed in whole or in part into a radiation protection apron (preferably an X-ray protection apron).

According to the invention, the radiation protection device may be part of an X-ray apron or be an X-ray apron.

According to the invention, the metal-containing coating may preferably be applied by adhesion by an extrusion method. These embodiments of the invention are advantageous in particular for X-ray aprons. As an alternative or in addition to lead and/or bismuth, antimony and/or tin and/or barium and/or oxides thereof may be provided in the metal-containing coating for radiation protection.

The present invention also has the advantage that seams can be sealed retroactively, for example by laminating along the seams.

A further advantage of the present invention is that the material (in other words the metals) and the hot melt are easy to separate and thus easy to recycle and reuse. When clothes or textiles are produced, cutting scraps can be melted in and returned to the processing.

According to the invention, the metal-containing layer includes elemental metal particles, metal oxides or metal salts. The support, in other words the fabric layer or textile woven fabric among other options, may also comprise a woven fabric layer, the fibres of which are coated with the coating according to the invention or provided with the metal-containing layer.

The invention further relates to the following embodiments:
Embodiment 1: Radiation protection device (10) comprising at least one metal-containing layer (14a, 14b) having a metal portion and a binder structure (18), the metal portion of the metal-containing layer (14a, 14b) being more than 50% by weight, characterised in that the binder structure (18) of the metal-containing layer (14a, 14b) has a Shore 00 hardness less than or equal to 100 and/or the binder structure (18) of the metal-containing layer (14a, 14b) has a density less than or equal to 1.1 g/cm³.
Embodiment 2: Radiation protection device (10) according to embodiment 1, characterised in that the binder of the binder structure (18) of the metal-containing layer (14a, 14b) comprises a hot melt.
Embodiment 3: Radiation protection device (10) according to either of the preceding embodiments, characterised in that the binder structure (18) of the metal-containing layer (14a, 14b) has a Shore 00 hardness of at least 95, preferably of at least 90, more preferably of at least 85, more preferably of at least 80, more preferably of at least 75, more preferably of at least 70, more preferably of at least 65.
Embodiment 4: Radiation protection device (10) according to any of the preceding embodiments, characterised in that the binder structure (18) of the metal-containing layer (14a, 14b) has a Shore 00 hardness of at most 25, preferably of at most 30, more preferably of at most 35, more preferably of at most 40, more preferably of at most 45, more preferably of at most 50, more preferably of at most 55, more preferably of at most 60.
Embodiment 5: Radiation protection device (10) according to any of the preceding embodiments, characterised in that at least 25% of the metal portion of the metal-containing layer (14a, 14b) is in the form of a metal oxide, preferably at least 30%, more preferably at least 35%, at least 40%, at least 45%, at least 50%, at least 55% or at least 60% of the metal portion of the metal-containing layer (14a, 14b) being in the form of a metal oxide.
Embodiment 6: Radiation protection device (10) according to any of the preceding embodiments, characterised in that at most 80% of the metal portion of the metal-containing layer (14a, 14b) is in the form of a metal oxide, preferably at most 75%, more preferably at most 70%, at most 65%, at most 60%, at most 55%, at most 50% or at most 45% of the metal portion of the metal-containing layer (14a, 14b) being in the form of a metal oxide.
Embodiment 7: Radiation protection device (10) according to any of the preceding embodiments, characterised in that the metal portion of the metal-containing layer (14a, 14b) comprises pure-metal-containing (=elemental metal) particles having a particle size of at most 110 μm, preferably at most 100 μm, more preferably at most 90 μm, at most 80 μm, at most 70 μm, at most 60 μm, at most 50 μm and at most 40 μm.
Embodiment 8: Radiation protection device (10) according to any of the preceding embodiments, characterised in that the metal portion of the metal-containing layer (14a, 14b) comprises pure-metal-containing (=elemental metal) particles having a particle size of at least 35 μm, preferably at least 40 μm, more preferably at least 50 μm, at least 60 μm, at least 70 μm, at least 80 μm, at least 90 μm and at least 100 μm.
Embodiment 9: Radiation protection device (10) according to any of the preceding embodiments, characterised in that the metal portion of the metal-containing layer (14a, 14b) has pure-metal-containing particles having a particle size of at least 140 mesh, preferably at least 170 mesh, more preferably at least 200 mesh, at least 250 mesh, at least 300 mesh, at least 350 mesh and at least 400 mesh.
Embodiment 10: Radiation protection device (10) according to any of the preceding embodiments, characterised in that the metal portion of the metal-containing layer (14a, 14b) has pure-metal-containing particles having a particle size of at most 400 mesh, preferably at most 350 mesh, more preferably at most 300 mesh, at most 250 mesh, at most 200 mesh, at most 170 mesh and at most 140 mesh.
Embodiment 11: Radiation protection device (10) according to any of the preceding embodiments, characterised in that the metal-containing layer (14a, 14b) has a metal portion or solids portion of at least 50% by weight, preferably at least 55% by weight, more preferably at least 60% by weight, at least 65% by weight, at least 70% by weight, at least 75% by weight, at least 80% by weight, at least 85% by weight, at least 90% by weight, at least 92% by weight.
Embodiment 12: Radiation protection device (10) according to any of the preceding embodiments, characterised in that the solids portion of the metal-containing layer (14a, 14b) has pure-metal-containing particles having an average diameter in a range of 5 μm to 100 μm, preferably in a range of 20 μm to 80 μm and more preferably in a range of 40 μm to 60 μm.
Embodiment 13: Radiation protection device (10) according to any of the preceding embodiments, wherein the metal-containing layer (14a, 14b) comprises bismuth and/or antimony and/or tin and/or barium and/or ions thereof.
Embodiment 14: Radiation protection device (10) according to any of the preceding embodiments, characterised in that the metal-containing layer (14a, 14b) comprises O²⁻ ions.
Embodiment 15: Radiation protection device (10) according to either embodiment 13 or embodiment 14, wherein the portion of bismuth and/or antimony and/or tin and/or barium and/or ions thereof comprises at least 50% by weight of the metal-containing layer (14a, 14b), preferably at least 55% by weight, more preferably at least 60% by weight, at least 65% by weight, at least 70% by weight, at least 75% by weight, at least 80% by weight, at least 85% by weight, at least 90% by weight or at least 92% by weight of the metal-containing layer (14a, 14b).
Embodiment 16: Radiation protection device (10) according to any of the preceding embodiments, wherein the metal-containing layer (14a, 14b) is applied by adhesion to a support or a support material or a fabric strip (12, 12a, 12b).
Embodiment 17: Radiation protection device (10) according to any of the preceding embodiments, wherein the metal-containing layer (14a, 14b) is applied to a support or a support material or a fabric strip (12, 12a, 12b) by powder-coating and/or calendering and/or lamination.
Embodiment 18: Radiation protection device (10) according to any of the preceding embodiments, wherein the radiation protection device (10) is formed multi-layer, the radiation protection device (10) being formed for example by multi-step powder coating and/or calendering and/or a combination thereof.
Embodiment 19: Radiation protection device (10) according to any of the preceding embodiments, characterised in that the radiation protection device can be applied to a support material.
Embodiment 20: Radiation protection device (10) according to any of the preceding embodiments, characterised in that the radiation protection device has at least one coating layer, comprising a metal active coating structure in each case and a binder structure which binds the active coating structure in each case, the portion of the active coating structure being in a range of 50% by weight to 90% by weight of the coating layer, and the portion of the binder structure of said coating layer being in a range of 8% by weight to 50% by weight of the coating layer.
Embodiment 21: Radiation protection device (10) according to embodiment 20, characterised in that the at least one coating layer has a layer thickness in a range of 0.1 millimetres to 2 millimetres, preferably 0.9 millimetres.
Embodiment 22: Support and/or support material and/or fabric strip having a radiation protection device according to any of the preceding embodiments.
Embodiment 23: Radiation protection garment (100), in particular an apron, protection garment, operation garment, work garment and/or glove, having a radiation protection device (10) according to any of embodiments 1 to 21 and/or one or more layers of a support and/or support material and/or fabric strip according to embodiment 22.
Embodiment 24: Textile in or on which a radiation protection device according to any of embodiments 1 to 21 is arranged as an inlay or overlay and/or which is manufactured using at least one fabric strip according to embodiment 22.
Embodiment 25: Protection lamella for an X-ray appliance, the protection lamellae having a radiation protection device according to any of embodiments 1 to 21 and/or at least one support and/or support material and/or fabric strip according to claim 22.
Embodiment 26: Method for manufacturing a radiation protection device according to any of embodiments 1 to 21 and/or a support and/or support material and/or fabric strip according to embodiment 22.
Embodiment 27: Method for manufacturing a material for a radiation protection device according to any of embodiments 1 to 21 and/or a support and/or support material and/or fabric strip according to embodiment 22, characterised in that the metal portion is predispersed with a first component of the binder, and the metal portion predispersed with the first component of the binder is dispersed with the other components of the binder.
Embodiment 28: Method for manufacturing a radiation protection device, comprising the following steps:
(c) providing a fabric layer of a textile woven fabric and
(c) applying a metal-containing material to the fabric layer or textile woven fabric to form a metal-containing layer, the metal-containing material having a metal portion and a binder, characterised in that the metal-containing material is prepared for application to the fabric layer or textile woven fabric by the following steps:
(b) dispersing the metal portion with the binder comprising a hot melt.
Embodiment 29: Method according to any of embodiments 26 to 28, characterised in that the hot melt comprises an a-PP.
Embodiment 30: Metal according to any of embodiments 26 to 29, characterised in that the hot melt comprises a block copolymer, for example SEBS.
Embodiment 31: Method according to any of embodiments 26 to 30, characterised in that the material is calendered using a transfer roller.
Embodiment 32: Method according to any of embodiments 26 to 30, wherein the material of the metal-containing layer is applied by adhesion by powder coating and/or calendering and/or injection moulding and/or blow moulding and/or lamination.
Embodiment 33: Method according to any of embodiments 26 to 32, wherein the metal layer is printed on a support and/or support material and/or fabric strip.
Embodiment 34: Method according to any of embodiments 26 to 33 for manufacturing the metal layer of a radiation protection device according to any of embodiments 1 to 21 or a support or support material or fabric strip according to embodiment 22, wherein the metal layer is applied to part of a textile or of an X-ray protection device and/or of an overlay or inlay for the textile or X-ray protection device.
Embodiment 35: Use of the radiation protection device according to any of embodiments 1 to 21 or of a support and/or support material and/or fabric strip according to embodiment 22 as an inlay or overlay for an X-ray protection device and/or textile.

According to the invention, the embodiments of the invention may advantageously be combined with one another. This applies both to the aforementioned embodiments of the invention and to the following embodiments of the invention.

Hot melts are substances in which the elastic polymer chains can be processed as a thermoplastic material in a purely physical process combining high shear forces, introduction of heat and subsequent cooling. Although chemical cross-linking by time-consuming, high-temperature vulcanisation, as with elastomers, is not required, the manufactured parts do have rubber-like properties as a result of their special molecular structure.

Reintroduction of heat and shear forces in turn leads to the material melting and deforming. This means that hot melts have less thermal and dynamic load capacity than standard elastomers. Hot melts are not a successor product to conventional elastomers, but rather supplement them, combining the processing advantages of thermoplastic material (thermoplastics) with the substance properties of elastomers.

Hot melts can be extruded, injection-moulded or even blow-moulded. They can be applied by adhesion using nozzles, extrusion, melt-blowing, spiral moulding, screen printing and slotted-nozzle coating.

It has been found to be particularly advantageous to apply the hot melt by powder coating.

Within the meaning of the present invention, powder coating means a method in which the powder is scattered uniformly on a substrate. Subsequently, the powder is heated until it melts. Subsequently, a woven fabric layer is applied under pressure and temperature, for example in a gap between a roller pair.

The hot melt may advantageously be prepared in the form of microgranulates. It has been found to be advantageous to use microgranulates having a particle size of at most 1000 μm in at least one spatial dimension.

Preferably, the particle size in at least one spatial dimension of these hot melt microgranulates is in a range of 10 μm to 1000 μm or in a range of 50 μm to 500 μm or in a range of 0.1 μm to 300 μm or in a range of 20 μm to 400 μm.

Using microgranulates of this type results in time and cost advantages, in particular because they have very good pourability and excellent melting properties and also make dust-free processing possible.

As an alternative or in addition to powder coating, a hot melt may also be applied to a support layer by calendering. The hot melt may equally well be extruded. Alternatively or in addition, the hot melt may be injection-moulded. Alternatively or in addition, the hot melt may be blow-moulded.

According to the invention, in particular for injection-moulding, silicone may be used as a (further) binder in addition to the hot melt.

The hot melts can be classified into the following product groups, copolymers and elastomer alloy, whereas these hot melts are distinguished by their inner structure.

Copolymers are used either as random or as block copolymers. The former consist of a crystallising (and thus physically cross-linking) primary polymer such as polyethylene, the degree of crystallisation of which is lowered sufficiently, by a comonomer such as vinyl acetate incorporated at random along the chain, that the crystallites (=hard phase) in the end product (for example EVA) no longer have any direct contact. They then act as isolated cross-linking points, as in conventional elastomers.

Because of the aforementioned special properties of hot melts as a binder for the metal layer it is surprisingly possible to introduce the high metal portion into the metal layer and to apply the metal layer to a support material by powder coating or calendering or extrusion or injection moulding (if the support material is introduced into the mould beforehand) or blow moulding.

The use of the metals cited in the present application, alone or in combination with elemental lead or lead compounds, reduces the weight of the radiation protection material or radiation protection device by comparison with the use of lead and/or lead compounds alone.

According to the invention, the metal-containing coating may include at least lead and/or tungsten and/or bismuth and/or antimony and/or tin and/or barium and/or oxides of the aforementioned metals, in an sufficient amount so that the metal-containing coating can be used as a radiation protection device for X-ray radiation.

The metals and/or oxides thereof may be used alone or in combination. As an alternative or in addition to bismuth, antimony may be provided in the metal-containing coating for the radiation protection. In addition, copper and/or zinc and/or tin and their ions and/or oxides may (but need not) be used in the metal-containing coating or in a further metal-containing coating so as to provide sterility against contaminants.

According to the invention, the material according to the invention or—if it is used in layer form—the metal layer or coating may have a metal portion or solids portion of at most 80% by weight (wt.-%), 75% by weight, 70% by weight, 69% by weight, or 68% by weight.

At the same time, the material according to the invention or—if it is used in layer form—the metal layer or coating may have a metal portion or solids portion of at least 50% by weight, 55% by weight, 60% by weight, 65% by weight, 70% by weight, 75% by weight, 80% by weight, 85% by weight, 90% by weight, 92% by weight, or 93% by weight.

Otherwise, the material according to the invention or—if it is used in layer form—the metal layer or coating may have a metal portion or solids portion of at most 93% by weight, 90% by weight or 85% by weight.

Within the meaning of the present invention, solids content is understood to be the portion which forms after the metal-containing coating sets.

The solids portion thus also includes the O²⁻ ions and the counter ions if metal salts or complexed metal compounds are used.

According to the invention, the material according to the invention or—if it is used in layer form—the metal layer or coating may comprise elemental bismuth and/or ions thereof.

According to the invention, the material according to the invention or—if it is used in layer form—the metal layer or coating may comprise elemental antimony and/or ions thereof.

According to the invention, the material according to the invention or—if it is used in layer form—the metal layer or coating may comprise elemental tin and/or ions thereof.

According to the invention, the material according to the invention or—if it is used in layer form—the metal layer or coating may comprise elemental barium and/or ions thereof.

If the layer is used as a coating of a material, as described herein, it may be formed over the full area of at least one face of the material, meaning that the coating covers the outer face and/or inner face over the entire area.

Alternatively, the coating may also cover only a sub-area or regions or a part or parts of the outer face and/or inner face. The covered regions or parts should preferably be selected in such a way that the regions or parts on the two faces supplement each other to form shielding over the full area, as required for the intended use of the radiation protection device.

According to the invention, metal coatings having different metals or metal oxides can be provided on specific areas/regions. Optionally, dyes or colour pigments may additionally be provided. In this way, patterns and/or inscriptions and/or symbols may be provided on the radiation protection device, and may serve for example for differentiation from one with another. For example, the radiation protection device could be provided with an identification for use, to ensure that the radiation protection device is used for the correct field of use.

According to the invention, the radiation protection device may comprise a plurality of metal-containing layers and/or fabric layers comprising a metal-containing layer.

According to the invention, the radiation protection device may have a first fabric layer and/or a plurality of fabric layers, of which at least one is provided with a metal-containing layer.

In an embodiment of the invention, a method for manufacturing a radiation protection device is also set out, comprising the following steps:
(a) Use of a fabric or a textile woven fabric; and
(b) dispersing the metal portion with the binder, which comprises a hot melt;
(c) applying a metal-containing material to the fabric or the textile woven fabric to form a metal-containing layer, whereas the metal-containing material having a metal portion and a binder, comprising a first component and at least one further component.

In tests using a hot melt comprising a-PP and/or SEBS as a polymer component, it has surprisingly been found that metal (for example bismuth) could be introduced into the hot melt in a sufficient amount and processed further. This was surprising in that the melting point of all or many metals (for example bismuth) is above the processing temperature for applying or preparing the material, namely approximately 180° C. to 210° C.

Contrary to expectations, it could be established that, surprisingly, no cavities occurred and the material to be applied did not include any undesired agglomerates. Presumably this surprising effect is due to the low-shear predispersion of the metal portion with the hot melt. Thus, according to the invention, a metal-containing layer having a high metal portion and a soft nature can be applied to a support fabric, and this was previously unknown and was not to be expected from the prior art.

According to the invention, the hot melt may comprise a-PP as a polymer component.

According to the invention, the hot melt may additionally or alternatively comprise SEBS as a polymer component.

According to the invention, the hot melt may additionally or alternatively comprise at least one further, different polymer component.

According to the invention, the hot melt may comprise further, different components.

According to the invention, a further, different component of the hot melt may be added during predispersion.

According to the invention, further, different components of the hot melt may be added during predispersion.

According to the invention, a further, different component of the hot melt may be added after predispersion and before the metal component, predispersed with the first component of the hot melt, is dispersed with the at least one further component of the hot melt.

According to the invention, further, different components of the hot melt may be added after predispersion and before the metal component, predispersed with the first component of the hot melt, is dispersed with the at least one further component of the hot melt.

According to the invention, a further, different component of the hot melt may be added when the metal component, predispersed with the first component of the hot melt, is being dispersed with the at least one further component of the hot melt.

According to the invention, further, different components of the hot melt may be added when the metal component, predispersed with the first component of the hot melt, is being dispersed with the at least one further component of the hot melt.

According to the invention, the predispersion may be low-shear.

According to the invention, the dispersion may be low-shear.

According to the invention, the metal-containing material may be calendered.

According to the invention, the metal-containing material may be calendered using a transfer roller.

According to the invention, the metal-containing material may be calendered using a transfer roller, only part of the material on the transfer roller being transferred from the transfer roller. In other words, the transfer roller is not run empty.

According to the invention, the metal-containing material may be transferred onto a support fabric. The support fabric may for example be a microfibre fabric.

According to the invention, the metal-containing material may be extruded.

According to the invention, the metal-containing material may be extruded using a planetary roller extruder.

The use of planetary roller extruders is advantageous because smaller shear forces act on the material and less pressure is exerted, and so the risk of reagglomeration is reduced.

It is advantageous if there are no nozzles for the application, since as a result smaller shear forces act and less pressure is exerted.

According to the invention, the metal-containing material may be supplied to a calender.

According to the invention, the metal-containing material may be supplied to a 4-roller calender.

According to the invention, the metal-containing material may be smoothed.

According to the invention, the metal-containing material may be smoothed using a calender.

According to the invention, the metal-containing material may be smoothed using a 4-roller calender.

The applied metal-containing coating may have a layer thickness of 10 μm to 50 μm. Preferably, the layer thickness may be 25 μm.

According to the invention, the radiation protection device may have a lead equivalent of at least 0.17.

According to the invention, the radiation protection device may have a lead equivalent of at least 0.20.

According to the invention, the radiation protection device may have a lead equivalent of at least 0.23.

According to the invention, the radiation protection device may have a lead equivalent of at least 0.25.

In an embodiment of the invention, a protection lamella for an X-ray appliance is also set out, the protection lamella having at least one radiation protection device or fabric strip according to the invention. This embodiment has the advantage over the prior art that a relatively high lead equivalent can be provided, removing the need to sew two layers of lamellae together. According to the invention, for a thickness of the radiation protection device of 0.8 mm or a layer thickness of the metal-containing layer of 0.8 mm, a lead equivalent of 0.35 can be achieved. Accordingly, according to the invention, for a thickness of the radiation protection device of 0.4 mm or a layer thickness of the metal-containing layer of 0.4 mm, a lead equivalent of 0.175 can be achieved, since the lead equivalent is proportional to the thickness.

Protection lamellae of this type may be used for example in X-ray appliances which are used in security checks at airports. For example, checked-in suitcases or hand luggage are scanned with them.

According to the invention, there is also the advantage that the lamellae can be sealed or laminated together, and this is faster and simpler than the known sewing and creates a more durable product.

According to the invention, a protection layer may be applied by adhesion to the metal-containing layer.

According to the invention, the protection layer may be formed transparent.

According to the invention, the protection layer may be formed single-colour or multicolour.

According to the invention, the protection layer may be provided with a design and/or logo.

According to the invention, the protection layer may be formed as a metal-containing coating.

The present invention further relates to a fabric strip comprising a radiation protection device according to the invention.

The present invention further relates to a radiation protection garment, comprising a radiation protection device according to the invention and/or one or more layers comprising a radiation protection device according to the invention and/or one or more fabric strips comprising a radiation protection device according to the invention. By way of non-limiting example, the radiation protection garment may be an apron, a protection garment, an operation garment, a work garment and/or a glove.

According to the invention, the radiation protection device may comprise a metal-containing layer or a plurality of metal-containing layers. Each metal-containing layer may have at least two different structural portions, namely an active coating structure and a binder structure. This same metal-containing layer may be applied by adhesion as a coating to any desired support material, and thus achieve a great effect at a low weight.

The active coating structure comprises a metal base composition, and the element(s) of this base composition are to be selected in accordance with a required effect. By way of non-limiting example, lead and/or bismuth and/or antimony and/or tin and/or barium and/or lead and/or oxides thereof and/or an alloy of bismuth and/or antimony and/or tin and/or barium and/or lead and/or oxides thereof may act as a radiation protection layer. The metal active elements may be mixed together in a single metal-containing layer and/or each be separated as a separate metal-containing layer.

The binder structure thus has the primary function of binding the particles of the active coating structure, in such a way that said structure can produce its effect, namely radiation protection.

It has been found to be advantageous for the portion of the active coating structure of the at least one metal-containing layer to be between fifty percent by weight and sixty-eight percent by weight, inclusive, of the metal-containing layer; and for the portion of the binder structure of the metal-containing layer to be between two percent by weight and ten percent by weight, inclusive, of the metal-containing layer. Such a low portion of binder structure may be surprising, but tests have shown that this results in a sufficient binding effect, so that the focus can be placed on the functional active coating structure. For weight reduction, it is advantageous for as little metal-containing layer as possible to be applied, but with as high a portion as possible of the active coating structure as a coating.

According to the invention, the metal-containing layer may be applied by adhesion to the support material by extrusion.

In the context of the present disclosure, unless stated otherwise, the specifications of percentages by weight always refer to dry weight.

According to the invention, the radiation protection device may have two or more metal-containing layers, applied by adhesion to one another. These metal-containing layers may each have a different or identical composition. If the metal-containing layers have different compositions, different functions of different active coating structures may be exploited, for example. Accordingly, an active coating structure comprising copper as an outermost coating layer may be provided for sterilisation, it being possible for one or more coating layers comprising lead and/or bismuth and/or antimony and/or tin and/or barium and/or oxides thereof to be arranged between this coating layer and the carrier material for radiation protection. Thus, a self-sterilising radiation protection device which simultaneously protects against radiation can be created. A plurality of similar metal-containing layers may follow one another so as to ensure and/or reinforce the effect of the specific active coating structures. Even if the coating layers exclusively each have the same composition, this can ensure and/or reinforce the effect of the specific active coating structures. Moreover, haptics and/or optics required for a specific scenario can also be set by way of the configuration of the coating layers.

According to the invention, the at least one coating layer may have a layer thickness between 0.1 millimetres and 2 millimetres, inclusive, preferably 0.8 millimetres.

According to the invention, the at least one metal-containing layer may have a layer thickness between ten micrometres and three hundred micrometres, inclusive. It has been found that in this way a weight-optimised radiation protection device which is still equipped with an effective functionality can be provided.

According to the invention, a respective layer thickness can be varied if there are a plurality of metal-containing layers. Thus, the effective functionality can be set as required while taking account of coating material costs.

According to the invention, the active coating structure may comprise barium, antimony, tin, bismuth, oxides thereof and/or an alloy thereof. It may also comprise lead and oxides thereof, if 100% lead or reduced-lead materials and devices are to be manufactured.

Barium has a density of 3.62 g/cm³ at twenty degrees Celsius, and is thus among the light metals. At a Mohs hardness of 1.25, it is comparatively soft and also the softest of the alkaline earth metals.

Bismuth has a density of 9.78 g/cm³ at twenty degrees Celsius.

It has been found that a combination or even individual use of the elements barium, antimony, tin and bismuth makes an advantageous active coating structure for radiation protection possible. A radiation protection device of this type may for example be used for X-ray aprons. In one embodiment of the invention, there is more than one coating layer comprising the above alloy configuration, so as to ensure that radiation which has passed through an outer coating layer is captured by one or more coating layers below. Particularly in an embodiment of the invention, in a non-limiting manner, the outermost coating layer may comprise a decontaminated metal, for example copper or an alloy thereof. This can thus constitute a lightweight replacement for the otherwise very heavy and cumbersome lead aprons as an X-ray apron. In addition to the equally effective radiation protection, as an alternative to the lead apron there is thus the advantage of lower weight and optional self-sterilisation.

The metal-containing layer closest to the support material may optionally be selected in such a way that the metal operative coating structure interacts with the support material, in such a way that particular effective functionalities can be promoted or that undesired effective functionalities can be neutralised by an appropriately selected metal-containing layer.

According to the invention, the content of the active microparticles may be between one percent by weight and six percent by weight, inclusive, of the total binder structure for each metal-containing layer. It has been found that a distribution of this type makes an advantageous effect of the active microparticles possible without detracting from the binding effect of the binder structure.

According to the invention, if there are a plurality of metal-containing layers, the portion of the active microparticles in the metal-containing layers may be different. This increases the usage options of the radiation protection device and the control over the effects of individual metal-containing layers of the radiation protection device. By way of example, active microparticles may be present predominantly in the lower metal-containing layers. This reduces the costs because of the reduced use of active microparticles, the effect of the active microparticles being exploited only in the deeper metal-containing layers, in such a way that, in the metal-containing layers above, the functionality of the binder structure can be focussed exclusively on the binding effect.

According to the invention, if there are a plurality of coating layers, the portion of the active microparticles is less in a metal-containing layer further from the support material than in a metal-containing layer closer to the support material.

According to the invention, at least eighty percent of the particles in the active coating structure may have an average cross section of ten micrometres to one hundred micrometres, inclusive. It has been found that an optimum effective functionality can be set in this way.

According to the invention, at least eighty percent of the particles in the active coating structure may have an average cross section of twenty micrometres to eighty micrometres, inclusive. It has been found that an optimum effective functionality can be set in this way.

A device for covering a body part, the device having a radiation protection device according to at least one of the aforementioned features, is also advantageous. By way of non-limiting example, the device may be a protection mask or a wearable apron element. By way of non-limiting example, the device for covering a body part may also be formed as an overall, a collar, a jacket, a waistcoat, trousers, dungarees, a glove, boots or even rubber boots. It may also be made from the manufactured fabric. By way of example, it is possible for the device for covering a body part to be applied, for example sewn, to a garment, for example retroactively, or for the garment inertly to comprise the device for covering a body part.

According to the invention, the metal layer may be arranged in or on a textile as an inlay and/or overlay. For use as X-ray protection, the metal layer may preferably comprise bismuth. The binder may be hot melt. As an alternative or in addition to bismuth, lead and/or barium and/or antimony and/or tin and/or oxides thereof may be provided in the metal-containing coating for radiation protection.

The metal-containing layer may be applied by adhesion to a support or support material or fabric strip by powder coating and/or calendering. According to the invention, the support may be left with the metal-containing layer, and the metal-containing layer along with the support may be arranged in or on a textile as an inlay and/or overlay. Alternatively or in addition, the metal-containing layer may also be applied directly to a part of the textile, and/or an overlay or inlay for the textile may be applied or arranged by powder coating and/or calendering. The part of the textile and/or the overlay or inlay then serve as a support for the metal-containing layer.

The invention has the advantage that, even with a high metal portion (pure metal or compounds thereof), high elasticity can still be achieved. In general, % by weight are always specified herein, it being possible for the ratio of metal portion to binder portion to be in the region of 7:3 or 70 wt.-% metal and 30 wt.-% binder.

According to the invention, the at least one metal-containing layer or the metal-containing layers may be applied by adhesion to a support or support material or fabric strip, for example by powder coating and/or calendering and/or lamination.

According to the invention, the at least one metal-containing layer or the metal-containing layers may be applied by adhesion between two support materials or fabric strips, for example by powder coating and/or calendering and/or lamination.

According to the invention, the support material or fabric strip may comprise TPU. This applies to all embodiments of the invention, including the embodiments with a carrier material or material strip and the embodiments with a support material or fabric strip on both sides of the at least one metal-containing layer or the plurality of metal-containing layers.

According to the invention, the metal-containing layer or the plurality of metal-containing layers may have a thickness of more than 0.1 mm.

According to the invention, the metal-containing layer or the plurality of metal-containing layers may have a minimum thickness of 0.2 mm, 0.3 mm, 0.4 mm, 0.5 mm, 0.6 mm, 0.7 mm or 0.8 mm.

According to the invention, the metal-containing layer or the plurality of metal-containing layers may have a maximum thickness of 2 mm, 1.8 mm, 1.6 mm, 1.5 mm, 1.4 mm, 1.3 mm, 1.2 mm, 1.1 mm, 1 mm or 0.9 mm.

Preferably, the layer thickness is in a range of 0.8 to 0.9 mm, in particular being approximately 0.8 mm.

According to the invention, the support material or fabric strip may have a minimum thickness of 50 μm, 60 μm, 70 μm, 80 μm or 90 μm.

According to the invention, the support material or fabric strip may have a maximum thickness of 150 μm, 140 μm, 130 μm, 120 μm or 110 μm.

Preferably, the layer thickness of the support material or fabric strip is in a range of 90-110 μm, in particular being approximately 100 μm.

According to the invention, the radiation protection device may be formed multi-layer. In this case, the radiation protection device may for example be formed by coextrusion. One layer or a plurality of layers may be the support material or fabric strip, which may for example be formed on one or both sides. The layer composite may for example comprise layers externally which include TPU. In the middle, at least one layer or a plurality of layers comprising hot melt may be provided.

The metal portion or the majority of the metal portion may preferably be provided there. A metal portion may also be provided in the outer layers.

According to the invention, the radiation protection device may be formed in such a way that it can be applied to a support material.

The invention thus also relates to a radiation protection device for textiles comprising a metal layer, which has as metal portion (lead and/or bismuth and/or antimony and/or tin and/or barium and/or oxides thereof) and a binder. The invention thus also relates to an X-ray apron comprising a protection device having a metal layer, which has a metal portion and a binder portion.

The binder may for example include polyurethane. As regards the relative amount ratios, reference is made to the amount ratios mentioned in the present disclosure. By way of example, approximately 70% bismuth may be provided. The textile may be an X-ray protection textile, for example an X-ray apron. As an alternative or in addition to bismuth, barium and/or antimony and/or tin and/or oxides thereof may be provided in the metal layer for radiation protection.

In the following, the invention is described in greater detail with reference to the example embodiments shown in the drawings, without limiting the general idea of the invention. In the various example embodiments, like reference numerals denote like or corresponding components or features. In each case, reference is made to the description of the other example embodiments of the invention, and the emphasis is placed on the differences from the other example embodiments. The following reference numerals are used:
10 Radiation protection device
12 Support material or fabric strip
12a Support material or fabric strip
12b Support material or fabric strip
14a Metal-containing layer
14b Metal-containing layer
16 Active coating structure
18 Binder structure
20 Active microparticles
100 Radiation protection garment
S1 Layer thickness
S2 Layer thickness

### BRIEF DESCRIPTION OF THE DRAWINGS

FIG. 1 is a schematic view of a radiation protection device according to a first embodiment of the invention;

FIG. 2 is a schematic view of a radiation protection device according to a second embodiment of the invention;

FIG. 3 is a schematic view of a radiation protection device according to a third embodiment of the invention;

FIG. 4 is a schematic view of a radiation protection device according to a fourth embodiment of the invention;

FIG. 5 is a schematic view of a radiation protection device according to a fifth embodiment of the invention;

FIG. 6 is a schematic view of a radiation protection device according to a sixth embodiment of the invention;

FIG. 7 is a schematic view of a radiation protection garment comprising a radiation protection garment according to an embodiment of the invention;

FIG. 8 is a comparison table setting out what Shore 00, Shore 0, Shore A, Shore B, Shore C and Shore D values correspond to each of the other Shore values, the material examples being intended merely for comparison.

### DETAILED DESCRIPTION

The example embodiments described in the following are merely examples, which can be modified and/or added to in various ways within the scope of the claims. Each feature described for a particular example embodiment may be used independently or in combination with other features in any other example embodiment. Each feature described for an example embodiment of a particular claim category may also be used correspondingly in an example embodiment of a different claim category.

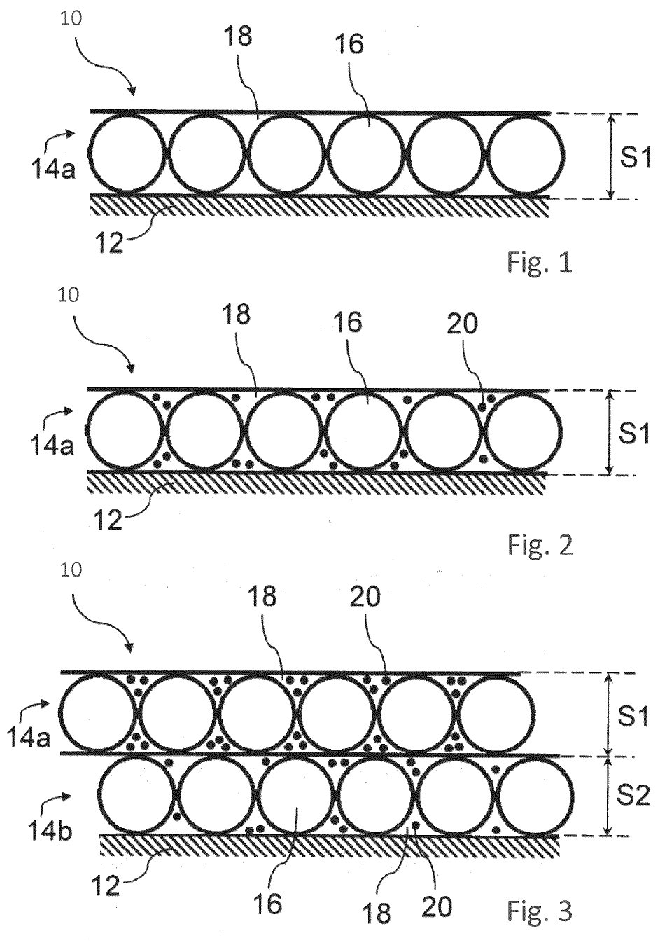

FIG. 1 to FIG. 4 each show an embodiment of a radiation protection device 10 according to the invention, which can be applied to a support material or fabric strip 12 or comprises a support material or fabric strip 12 to which one or more metal-containing layers 14a, 14b are applied.

For this purpose, the radiation protection device 10 has at least one metal-containing layer 14a, 14b, comprising a metal active coating structure 16 in each case and a binder structure 18 which binds the active coating structure 16 in each case; the portion of the active coating structure 16 of the at least one metal-containing layer 14a, 14b being between sixty percent by weight and eighty percent by weight, inclusive, preferably sixty-eight percent by weight of the metal-containing layer 14a, 14b; and the portion of the binder structure 18 of said metal-containing layer 14a, 14b being between twenty percent by weight and forty percent by weight, inclusive, preferably thirty-two percent by weight of the metal-containing layer 14a, 14b.

As is schematically shown in the drawings, the portion of the binder structure 18 of the at least one metal-containing layer 14a, 14b is between twenty percent by weight and forty percent by weight, inclusive, of the whole metal-containing layer 14a, 14b.

It is provided, at least in the example embodiments shown, that the metal-containing layer 14a, 14b consists of just the active coating structure 16 and the binder structure 18.

Although this is not discernible, according to an embodiment of the invention it is provided that the binder structure 18 includes hot melt or a mixture of different hot melts and optionally another component, such as silicone, as a binder.

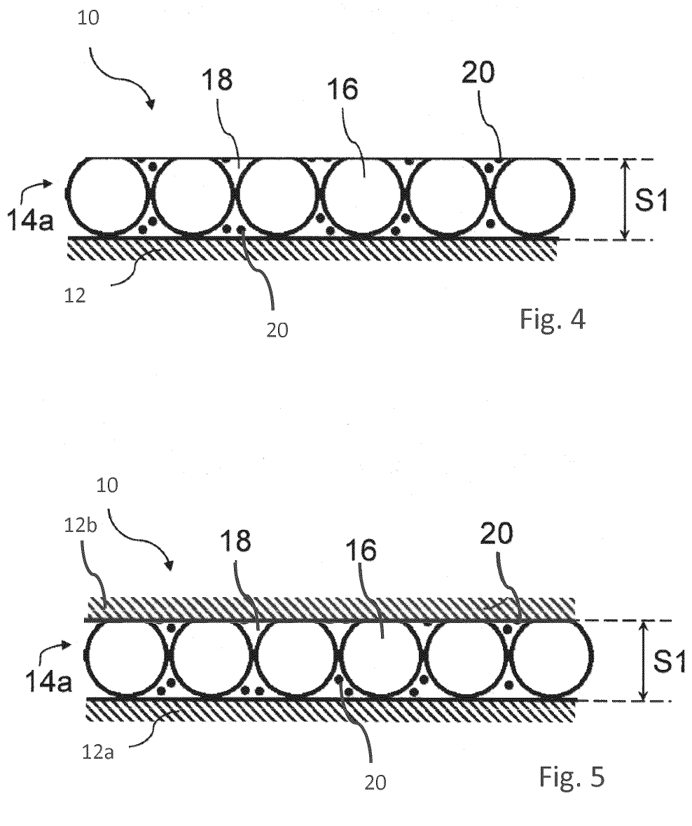

FIG. 3 shows, by way of non-limiting example, that the radiation protection device 10 has two metal-containing layers 14a, 14b applied to one another by adhesion. The actual number depends on what is required. A plurality of metal-containing layers are advantageous if for example high radiation protection is required. In the example embodiment shown simplified in FIG. 1, FIG. 2 and/or FIG. 4, there is a high probability that radiation could radiate through between the particles of one metal-containing layer 14a of the operative connecting structure 16. As a result of the active operative structures 16 of the two metal-containing layers 14a, 14b, radiation which has radiated through the first metal-containing layer 14a can be captured by the second metal-containing layer 14b. In principle, the radiation effect increases with an increasing number of metal-containing layers. However, attention should be paid to the amount and thus the weight of the layers so as to create a light and simultaneously also beneficial radiation protection device 10.

FIG. 3 further schematically shows, by way of example, that the two coating layers 14a, 14b each have a layer thickness S1, S2 between ten micrometres and three hundred micrometres, inclusive. Obviously this is shown considerably enlarged.

In all example embodiments, an embodiment of the invention provides that the active coating structure 16 includes one or more of the metals barium, bismuth, lead, antimony, tin, oxides thereof and/or an alloy thereof or ions thereof.

The example embodiments of FIG. 2 to FIG. 4 schematically provide that the binder structure 18 includes active microparticles 20, in particular metals or ions thereof.

Moreover, the example embodiments of FIG. 2 to FIG. 4 schematically provide that the portion of the active microparticles 20 is between one percent by weight and six percent by weight, inclusive, of the whole binder structure 18 for each coating layer 14a, 14b.

The example embodiment of FIG. 3 provides that the radiation protection device 10 is at least irradiated, ground and/or polished on the surface thereof remote from the support material 12.

The example embodiments of FIG. 2 to FIG. 4 schematically provide that at least eighty percent of the particles of the operative coating structure 16 have an average cross section of ten micrometres to one hundred micrometres, inclusive. Moreover, the example embodiments of FIG. 2 to FIG. 4 schematically provide that at least eighty percent of the particles of the operative coating structure 16 have an average cross section of twenty micrometres to eighty micrometres, inclusive.

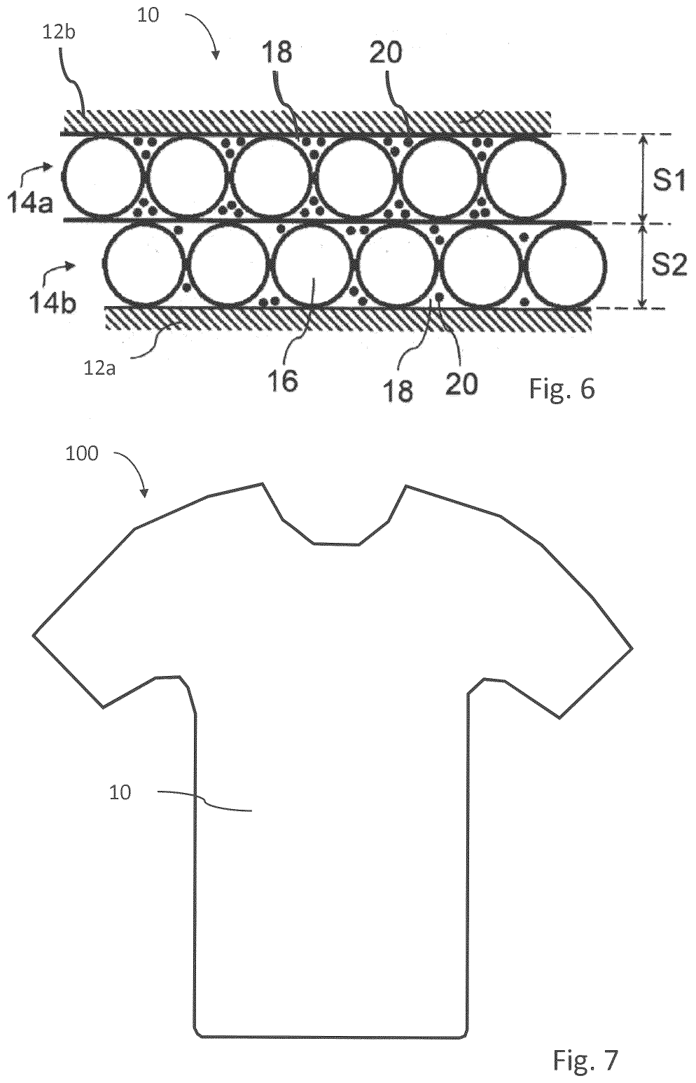

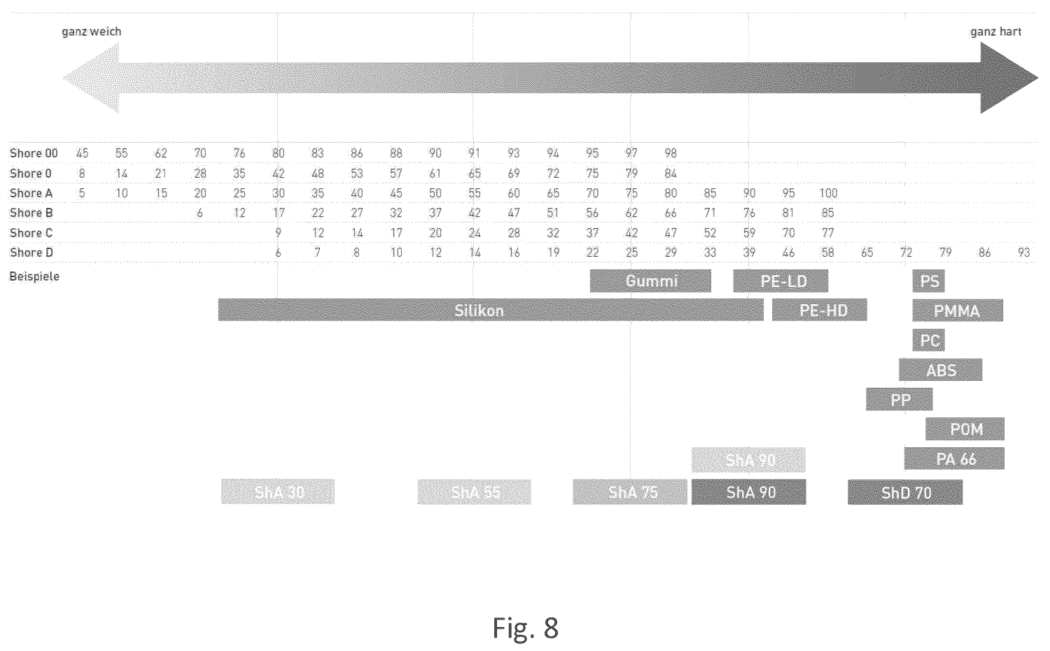

FIG. 5 and FIG. 6 each show an embodiment of a radiation protection device 10 according to the invention, one or more metal-containing layers 14a, 14b being arranged between a support material or fabric strip 12a and a further support material or further fabric strip 12b. Like reference numerals denote like or similar features. Reference is made to the description of the embodiments of FIGS. 1 to 4.

The one or more metal-containing layers 14a, 14b may be arranged between two polyester fabric strips 12a, 12b.

In an alternative embodiment, the one or more metal-containing layers 14a, 14b may be arranged between a polyester fabric strip 12a and a microfibre or TPU fabric strip 12b.

The one or more metal-containing layers 14a, 14b may be arranged between two microfibre or TPU fabric strips 12a, 12b.

FIG. 7 is a schematic view of a radiation protection garment 100 comprising one or more radiation protection devices according to an embodiment of the invention. An upper-body garment is shown. Equivalently, another suitable garment may also be provided depending on the object and purpose of the application.

Naturally, the invention is not limited to the embodiments shown in the drawings. The present description should therefore be considered explanatory rather than limiting. The following claims are to be understood to the effect that a stated feature is present in at least one embodiment of the invention. This does not exclude the presence of other features. Where the claims and the present description define “first” and “second” features, this designation serves to discriminate between two similar features, without establishing any ranking.

1. A radiation protection device comprising at least one metal-containing layer comprising a metal portion and a binder structure, the metal portion of the metal-containing layer being at least 50% by weight, wherein the binder structure of the metal-containing layer has a Shore 00 hardness of at most 100 and/or the binder structure of the metal-containing layer has a thickness of at most 1.1 g/cm3, the binder of the binder structure of the metal-containing layer containing a hot melt.

2. The radiation protection device according to claim 1, wherein the binder is a hot melt containing a base polymer selected from the group consisting of polyamides, polyethylenes, polypropylenes, ataxic polypropylenes, polyolefins, amorphous polyolefins, ethylene vinyl acetate, ethylene vinyl acetate copolymers EVAC, polyesters, polyester elastomers, polyurethane elastomers, copolyamide elastomers, vinyl pyrrolidone/vinyl acetate copolymers, styrene block copolymers, for example SEBS, polyethylene and polystyrene.

3. The radiation protection device according to claim 1, wherein the binder structure of the metal-containing layer has a Shore 00 hardness in a range of 30 to 95, and at least 25% and at most 80% metal portion of the metal-containing layer has been introduced in the form of a metal oxide.

4. The radiation protection device according to claim 1, wherein the metal portion of the metal-containing layer contains pure-metal-containing particles having a particle size in a range of 110 μm to 35 μm.

5. The radiation protection device according to claim 1, wherein the metal-containing layer has a metal portion or solids portion of at least 50% by weight and pure-metal-containing particles having an average diameter in a range of 5 μm to 100 μm.

6. The radiation protection device according to claim 1, wherein the metal-containing layer contains bismuth and/or antimony and/or tin and/or barium and/or lead in an elemental, ionic or complexed form, the metal-containing layer containing at least 50% by weight aforementioned metals in an elemental or ionic form.

7. The radiation protection device according to claim 1, wherein the metal-containing layer is applied by adhesion to a support, a support material or a fabric strip.

8. The radiation protection device according to claim 1, wherein the radiation protection device is formed multi-layer.

9. The radiation protection device according to claim 1, wherein the radiation protection device has at least one coating layer, comprising a metal active coating structure in each case and a binder structure which binds the active coating structure in each case, the portion of the active coating structure being in a range of 50% by weight to 90% by weight of the coating layer, and the portion of the binder structure of said coating layer being in a range of 8% by weight to 50% by weight of the coating layer.

10. The radiation protection device according to claim 9, wherein the at least one coating layer has a layer thickness in a range of 0.1 millimetres to 2 millimetres.

11. A protection lamella for an X-ray apparatus or X-ray protection garment, in particular an apron, protection garment, operation garment, work garment or glove, having a radiation protection device according to claim 1.

12. A method for manufacturing a material for a radiation protection device according to claim 1, wherein the metal portion is predispersed with a first component of the binder, and the metal portion predispersed with the first component of the binder is dispersed with the further components of the binder.

13. The method according to claim 12 for manufacturing a radiation protection device, comprising the following steps:
(a) providing a fabric layer of a textile woven fabric and
(c) applying a metal-containing material to the fabric layer or textile woven fabric to form a metal-containing layer, the metal-containing material having a metal portion and a binder, wherein the metal-containing material is prepared for application to the fabric layer or textile woven fabric by the following steps:
(b) dispersing the metal portion with the binder comprising a hot melt.

14. The method according to claim 13, wherein the material of the metal-containing layer is applied by adhesion by powder coating and/or calendering and/or injection moulding and/or blow moulding and/or lamination, the material being calendered using a transfer roll if calendering is used, or the metal layer being printed onto a support and/or support material and/or fabric strip.

15. The method according to claim 12 for manufacturing the metal layer of a radiation protection device, wherein the metal layer is applied to part of a textile or of an X-ray protection device, and/or an overlay or inlay for the textile or X-ray protection device is applied.

16. The radiation protection device according to claim 6, wherein further ions are present, the further ions including one counter ions or oxygen ions.

17. The radiation protection device according to claim 7, wherein the the metal-containing layer is applied by powder coating and/or calendering and/or lamination.

18. The radiation protection device according to claim 8, wherein the radiation protection device is formed by multi-step powder coating and/or calendering and/or a combination thereof
